(19) United States
(12) Patent Application Publication
(10) Pub. No.: US 2022/0181989 A1
(43) Pub. Date: Jun. 9, 2022

(54) POWER CONVERTER AND AIR CONDITIONER

(71) Applicant: Mitsubishi Electric Corporation, Tokyo (JP)

(72) Inventors: Keisuke UEMURA, Tokyo (JP); Shotaro KARASUYAMA, Tokyo (JP); Takaaki TAKAHARA, Tokyo (JP); Koichi ARISAWA, Tokyo (JP)

(21) Appl. No.: 17/617,397

(22) PCT Filed: Aug. 30, 2019
(86) PCT No.: PCT/JP2019/034298

§ 371 Date: Dec. 8, 2021

(51) Int. Cl. H02M 7/219; H02M 7/5387; H02P 27/08; F24F 11/88

(52) U.S. Cl. CPC H02M 7/219; F24F 11/88; H02P 27/08; H02M 7/53871

(57) ABSTRACT

A power converter includes: a converter that includes switching elements to convert alternating current (AC) power output from an AC power source into direct current (DC) power; a reactor disposed between the AC power source and the converter; a smoothing capacitor connected to both ends of a DC terminal of the converter; and detectors that detect a physical quantity representing an operational state of the converter. A bus voltage command value is issued that has zones respectively having different change rates during boost operation of the converter, where the change rates each represent how a bus voltage included in the physical quantity changes with a change in a magnitude of the load obtained from the physical quantity.

### CROSS REFERENCE TO RELATED APPLICATION

This application is a U.S. National Stage Application of International Patent No. PCT/JP2019/034298 filed on Aug. 30, 2019, the disclosure of which is incorporated herein by reference.

### TECHNICAL FIELD

The present invention relates to a power converter that converts alternating current (AC) power into direct current (DC) power, and to an air conditioner using such power converter.

### BACKGROUND

A power converter that converts AC power into DC power is installed in trains, automobiles, air conditioners, and the like. These products also include an inverter that converts the DC power output from the power converter into AC power having a predetermined frequency. The inverter supplies the AC power obtained by the conversion to a load such as a motor. In this regard, a power converter is required to achieve energy saving and noise reduction. Specifically, a power converter installed in an air conditioner effectively achieves high-efficiency, low-noise operation by switching the switching method depending on the load.

Patent Literature 1 discloses a technology in which a power converter that converts AC power into DC power includes semiconductor devices such as metal-oxide-semiconductor field-effect transistors (MOSFETs) as switching elements, and achieves energy saving and noise reduction by selectively switching the switching method of the semiconductor devices to one of diode rectification control, synchronous rectification control, partial switching control, and high-speed switching control.

### PATENT LITERATURE

Patent Literature 1: Japanese Patent Application Laid-open No. 2017-55489

However, upon switching the switching method from partial switching control to high-speed switching control, or from high-speed switching control to partial switching control, the power converter according to the foregoing conventional technology performs switching to keep the DC voltage at a constant value without causing a variation. This presents a problem in that the power converter undergoes an increase in leakage current due to charge and discharge currents of a parasitic capacitance of a switching element such as a MOSFET upon switching of the switching method.

### SUMMARY

The present invention has been made in view of the foregoing, and it is an object of the present invention to provide a power converter capable of reducing leakage current upon switching of the switching method.

To solve the above problems and achieve the object a power converter according to the present invention includes: a converter that converts alternating current power output from an alternating current power source into direct current power, the converter including switching elements; a reactor disposed between the alternating current power source and the converter; a smoothing capacitor connected to both ends of a direct current terminal of the converter; and a plurality of detectors that detect a physical quantity representing an operational state of the converter. A bus voltage command value is issued that has zones respectively having different change rates during boost operation of the converter, the different change rates each representing how a bus voltage included in the physical quantity changes with a change in a magnitude of a load obtained from the physical quantity.

A power converter according to the present invention provides an advantage in being capable of reducing leakage current upon switching of the switching method.

### BRIEF DESCRIPTION OF DRAWINGS

FIG. 1 is a diagram illustrating an example configuration of a power converter according to a first embodiment.

FIG. 2 is a block diagram illustrating an example configuration of the controller included in the power converter according to the first embodiment.

FIG. 3 is a diagram illustrating an AC current, and drive signals to respective MOSFETs from the controller, in a diode rectification method of passive operation controlled by the power converter according to the first embodiment.

FIG. 4 is a diagram illustrating the AC current, and the drive signals to the respective MOSFETs from the controller, in a synchronous rectification method of passive operation controlled by the power converter according to the first embodiment.

FIG. 5 is a diagram illustrating the AC current, and the drive signals to the respective MOSFETs from the controller, in a partial switching method controlled by the power converter according to the first embodiment.

FIG. 6 is a diagram illustrating the AC current, and the drive signals to the respective MOSFETs from the controller, in a high-speed switching method controlled by the power converter according to the first embodiment.

FIG. 7 is a first flowchart illustrating an operation of determination of the switching method performed by the controller of the power converter according to the first embodiment.

FIG. 8 is a second flowchart illustrating an operation of determination of the switching method performed by the controller of the power converter according to the first embodiment.

FIG. 9 is a third flowchart illustrating an operation of determination of the switching method performed by the controller of the power converter according to the first embodiment.

FIG. 10 is a flowchart illustrating an operation of computation of a bus voltage command value performed by the controller of the power converter according to the first embodiment.

FIG. 11 is a diagram illustrating a relationship between a load and a bus voltage when the switching method is switched from the passive operation to the high-speed switching method by the controller of the power converter according to the first embodiment.

FIG. 12 is a diagram illustrating a relationship between the load and a leakage current when the switching method is switched by the controller of the power converter according to the first embodiment.

FIG. 13 is a diagram illustrating waveforms of the AC current and of the leakage current at a bus voltage of 260 V in the high-speed switching method in the power converter of the first embodiment.

FIG. 14 is a diagram illustrating waveforms of the AC current and of the leakage current at a bus voltage of 270 V in the high-speed switching method in the power converter of the first embodiment.

FIG. 15 is a diagram illustrating a relationship between the load and the bus voltage in a case in which the switching method is switched from the passive operation to the partial switching method by the controller of the power converter according to the first embodiment.

FIG. 16 is a first diagram illustrating a relationship between the load and the bus voltage in a case in which the switching method is switched from the passive operation to the partial switching method and then from the partial switching method to the high-speed switching method by the controller of the power converter according to the first embodiment.

FIG. 17 is a second diagram illustrating a relationship between the load and the bus voltage in the case in which the switching method is switched from the passive operation to the partial switching method and then from the partial switching method to the high-speed switching method by the controller of the power converter according to the first embodiment.

FIG. 18 is a diagram illustrating relationships among the load, the bus voltage, and an average duty ratio in a case in which the switching method is switched from the passive operation to the high-speed switching method by the controller of the power converter according to the first embodiment.

FIG. 19 is a diagram illustrating a relationship between a power source short circuit duty ratio and the AC voltage from the AC power source detected by the power converter according to the first embodiment.

FIG. 20 is a diagram illustrating an example of hardware configuration that implements the controller included in the power converter according to the first embodiment.

FIG. 21 is a diagram illustrating an example configuration of a motor driver according to a second embodiment.

FIG. 22 is a diagram illustrating an example configuration of an air conditioner according to a third embodiment.

### DETAILED DESCRIPTION

A power converter and an air conditioner according to embodiments of the present invention will be described in detail below with reference to the drawings. Note that these embodiments are not intended to limit the scope of this invention.

### First Embodiment

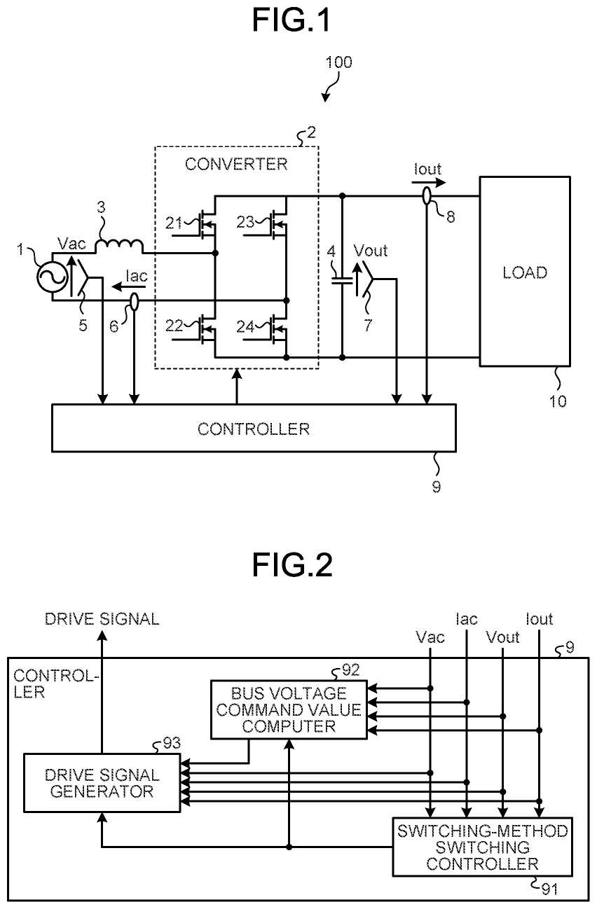

FIG. 1 is a diagram illustrating an example configuration of a power converter 100 according to a first embodiment of the present invention. The power converter 100 is connected to an alternating current (AC) power source 1 and to a load 10. The power converter 100 converts AC power output from the AC power source 1 into direct current (DC) power, and outputs the converted DC power to the load 10. The AC power source 1 is, for example, a commercial power supplied to residences. The load 10 is, for example, an inverter that converts DC power into AC power having a desired voltage, a motor installed in an air conditioner, and the like.

The power converter 100 includes a converter 2, a reactor 3, a smoothing capacitor 4, an AC voltage detector 5, an AC current detector 6, a bus voltage detector 7, a load current detector 8, and a controller 9.

In the power converter 100, one terminal of the AC power source 1 is connected to one terminal of the reactor 3, and another terminal of the reactor 3 is connected to one terminal of an AC terminal, which is an input terminal, of the converter 2. The reactor 3 is disposed between the AC power source 1 and the converter 2. In addition, the AC power source 1 has another terminal connected to another terminal of the AC terminal of the converter 2. The AC voltage detector 5 and the AC current detector 6 are disposed between the AC power source 1 and the converter 2. The AC voltage detector 5 detects an AC voltage Vac, which is an input voltage from the AC power source 1. The AC current detector 6 detects an AC current Iac, which is an input current from the AC power source 1.

In the power converter 100, the converter 2 has a DC terminal, which is an output terminal thereof, having both ends connected in parallel with the smoothing capacitor 4. In addition, both ends of the DC terminal of the converter 2 are connected with the load 10. The bus voltage detector 7 and the load current detector 8 are disposed between the converter 2 and the load 10. The bus voltage detector 7 detects an output voltage Vout from the converter 2, which is the voltage across both ends of the smoothing capacitor 4, and is the bus voltage. The load current detector 8 detects an output current Tout from the converter 2, which is the current flowing to the load 10.

The AC voltage detector 5, the AC current detector 6, the bus voltage detector 7, and the load current detector 8 each outputs a detection result to the controller 9. The detection results output from the AC voltage detector 5, the AC current detector 6, the bus voltage detector 7, and the load current detector 8 to the controller 9 are each a physical quantity representing an operational state of the converter 2. The controller 9 controls semiconductor devices that are switching elements included in the converter 2, based on the detection results obtained from the AC voltage detector 5, the AC current detector 6, the bus voltage detector 7, and the load current detector 8, that is, based on the physical quantities each representing an operational state of the converter 2. The controller 9 performs power factor improvement, bus voltage control, and the like, by controlling the semiconductor devices of the converter 2.

The converter 2 includes switching elements to convert the AC power output from the AC power source 1 into DC power. The converter 2 includes semiconductor devices that are the switching elements. The converter 2 illustrated in FIG. 1 is illustrated as an example using MOSFETs as the semiconductor devices, and having a full bridge configuration. The converter 2 includes MOSFETs 21, 22, 23, and 24 as the semiconductor devices serving as the switching elements. In the converter 2, the source of the MOSFET 21 and the drain of the MOSFET 22 are connected to each other, and one end of the AC power source 1 is connected to the junction point of the MOSFET 21 and the MOSFET 22 via the reactor 3. Also in the converter 2, the source of the MOSFET 23 and the drain of the MOSFET 24 are connected to each other, and another end of the AC power source 1 is connected to the junction point of the MOSFET 23 and the MOSFET 24. In addition, in the converter 2, the drain of the MOSFET 21 and the drain of the MOSFET 23 are connected to each other, and the source of the MOSFET 22 and the source of the MOSFET 24 are connected to each other. The semiconductor devices used in the converter 2 may each be, instead of a MOSFET, an insulated gate bipolar transistor (IGBT) or a diode using an element such as GaN or SiC. Use of a diode requires at least one switching element in addition to the diode.

FIG. 2 is a block diagram illustrating an example configuration of the controller 9 included in the power converter 100 according to the first embodiment. The controller 9 includes a switching-method switching controller 91, a bus voltage command value computer 92, and a drive signal generator 93. The detection results from the AC voltage detector 5, from the AC current detector 6, from the bus voltage detector 7, and from the load current detector 8 are input to the switching-method switching controller 91, to the bus voltage command value computer 92, and to the drive signal generator 93.

The switching-method switching controller 91 determines the switching method of the converter 2, more specifically, the switching method of the MOSFETs 21 to 24, which are the semiconductor devices included in the converter 2, based on the detection results obtained from the AC voltage detector 5, the AC current detector 6, the bus voltage detector 7, and the load current detector 8. The switching-method switching controller 91 switches the switching method of the MOSFETs 21 to 24 using the result of determination of the switching method. The switching-method switching controller 91 outputs the result of determination of the switching method to the bus voltage command value computer 92 and to the drive signal generator 93. An operation of the switching-method switching controller 91 will be described in detail later.

The bus voltage command value computer 92 computes a bus voltage command value based: on the detection results obtained from the AC voltage detector 5, from the AC current detector 6, from the bus voltage detector 7, and from the load current detector 8; and on the switching method determined by the switching-method switching controller 91. The bus voltage command value computer 92 outputs the computed bus voltage command value, to the drive signal generator 93. An operation of the bus voltage command value computer 92 will be described in detail later.

The drive signal generator 93 generates a drive signal for the converter 2 based: on the detection results obtained from the AC voltage detector 5, from the AC current detector 6, from the bus voltage detector 7, and from the load current detector 8; on the switching method determined by the switching-method switching controller 91; and on the bus voltage command value computed by the bus voltage command value computer 92. A drive signal for the converter 2 is a signal for controlling switching of each of the MOSFETs 21 to 24, which are the semiconductor devices included in the converter 2. The drive signal generator 93 outputs the generated drive signal to the converter 2.

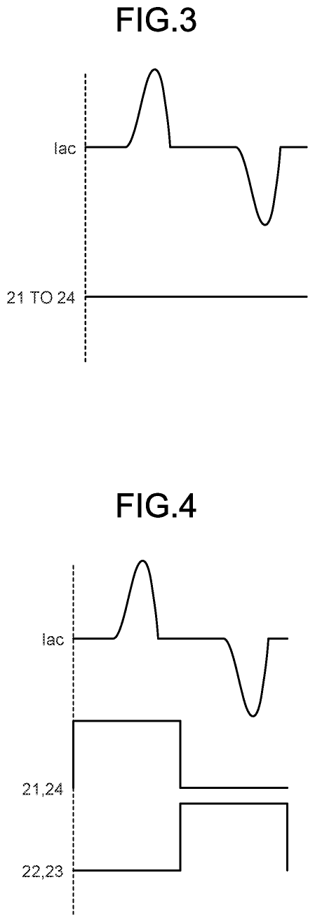

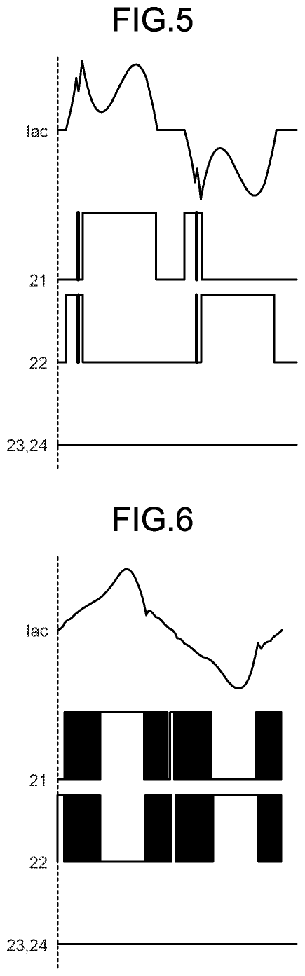

The switching method will now be described that is controlled by the controller 9 using the MOSFETs 21 to 24, which are the semiconductor devices included in the converter 2, in the power converter 100. FIG. 3 is a diagram illustrating the AC current Iac and the drive signals to the respective MOSFETs 21 to 24 from the controller 9 in a diode rectification method of passive operation controlled by the power converter 100 according to the first embodiment. FIG. 4 is a diagram illustrating the AC current Iac and the drive signals to the respective MOSFETs 21 to 24 from the controller 9 in a synchronous rectification method of passive operation controlled by the power converter 100 according to the first embodiment. FIG. 5 is a diagram illustrating the AC current Iac and the drive signals to the respective MOSFETs 21 to 24 from the controller 9 in a partial switching method controlled by the power converter 100 according to the first embodiment. FIG. 6 is a diagram illustrating the AC current Iac and the drive signals to the respective MOSFETs 21 to 24 from the controller 9 in a high-speed switching method controlled by the power converter 100 according to the first embodiment.

As described above, the switching-method switching controller 91 has the passive operation, the partial switching method, and the high-speed switching method as the switching methods that are switchable therebetween. FIGS. 3 to 6 each illustrate an example of the drive signals to the respective MOSFETs 21 to 24 in a case in which the converter 2 has a full bridge configuration, the MOSFETs 21 and 22 together form a switching arm, and the MOSFETs 23 and 24 together form a synchronous rectification arm. Note that for simplicity of illustration, FIGS. 3 to 6 indicate the drive signals to the respective MOSFETs 21 to 24 by only the reference numbers representing the respective MOSFETs 21 to 24.

The passive operation refers to switching methods having no boost operation of the converter 2, including two methods that are diode rectification method and synchronous rectification method. The diode rectification method is a switching method in which, as illustrated in FIG. 3, the MOSFETs 21 to 24 are turned off, that is, the drive signals to the MOSFETs 21 to 24 are turned off, during the entire period of the AC power source 1. The synchronous rectification method is a switching method in which the MOSFETs 21 to 24 are controlled as illustrated in FIG. 4 such that the MOSFETs 21 and 24 are turned on and off at a same timing and the MOSFETs 22 and 23 are turned on and off at a same timing in synchronization with the polarity of the power from the AC power source 1. Note that, in the first embodiment, the diode rectification method and the synchronous rectification method may both be used as the passive operation, or only one of the diode rectification method and the synchronous rectification method may be used as the passive operation. The passive operation in the first embodiment includes at least one switching method of the diode rectification method and the synchronous rectification method.

The partial switching method is a switching method in which, as illustrated in FIG. 5, control is repeatedly performed, by the MOSFETs 21 and 22 serving as the switching arm, to partially short-circuit the reactor 3 to the AC power source 1 during a half period of the AC power source 1, up to a specified number of times. In the partial switching method, the drive signals to the MOSFETs 23 and 24 serving as the synchronous rectification arm are turned off.

The high-speed switching method is a switching method in which, as illustrated in FIG. 6, switching is performed, by the MOSFETs 21 and 22 serving as the switching arm, to short-circuit the reactor 3 at a specified frequency during the entire AC period of the AC power source 1. In the high-speed switching method, the drive signals to the MOSFETs 23 and 24 serving as the synchronous rectification arm are turned off.

Note that the drive signals to the respective MOSFETs 21 to 24 in each switching method illustrated in FIGS. 3 to 6 are merely by way of example, and are not limited thereto. For example, the partial switching method and the high-speed switching method may be performed in which the MOSFETs 23 and 24 serving as the synchronous rectification arm are switched in the synchronous rectification method in which switching is performed in synchronization with the polarity of the AC power source 1. In addition, the MOSFETs 21 and 22 may be used as the synchronous rectification arm, and the MOSFETs 23 and 24 may be used as the switching arm. In the first embodiment, the diode rectification method, the synchronous rectification method, the partial switching method, and the high-speed switching method respectively correspond to the diode rectification control, the synchronous rectification control, the partial switching control, and the high-speed switching control described in Patent Literature 1. Description of the detail of each switching method will therefore be omitted.

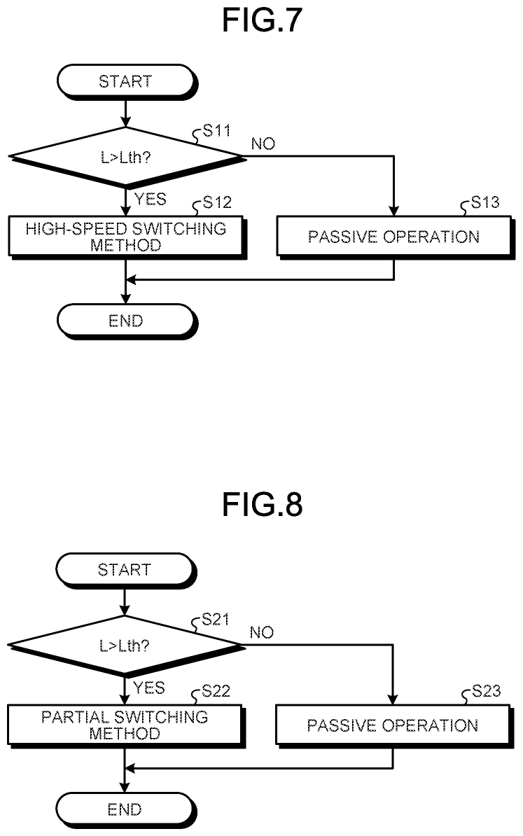

An operation of the controller 9 will next be described which controls the switching method of the converter 2 in the power converter 100. FIG. 7 is a first flowchart illustrating an operation of determination of the switching method performed by the controller 9 of the power converter 100 according to the first embodiment. Referring to FIG. 7, a case will be described in which the controller 9 switches between the high-speed switching method and the passive operation as the switching method of the converter 2. In the controller 9, the switching-method switching controller 91 compares a load L, which represents the magnitude of the AC power supplied from the converter 2 to the load 10, with a predetermined threshold Lth (step S11).

The switching-method switching controller 91 may calculate the load L using, for example, the output voltage Vout detected by the bus voltage detector 7, the output current Tout detected by the load current detector 8, or the like, but the calculation method is not limited thereto. The switching-method switching controller 91 needs only to know the condition of the AC power supplied to the load 10. Therefore, the load L to be compared with the threshold Lth may be the output voltage Vout or the output current Tout. Moreover, the switching-method switching controller 91 may use any parameter, other than the load L, that represents the operational state of the converter 2 such as the load L, including the AC voltage Vac detected by the AC voltage detector 5 and the AC current Iac detected by the AC current detector 6. This also applies to the description below.

If the load L is greater than the threshold Lth (step S11: Yes), the switching-method switching controller 91 selects the high-speed switching method as the switching method of the converter 2 (step S12). If the load L is less than or equal to the threshold Lth (step S11: No), the switching-method switching controller 91 selects the passive operation as the switching method of the converter 2 (step S13).

FIG. 8 is a second flowchart illustrating an operation of determination of the switching method performed by the controller 9 of the power converter 100 according to the first embodiment. Referring to FIG. 8, a case will be described in which the controller 9 switches between the partial switching method and the passive operation as the switching method of the converter 2. In the controller 9, the switching-method switching controller 91 compares the load L, which represents the magnitude of the AC power supplied from the converter 2 to the load 10, with the predetermined threshold Lth (step S21). If the load L is greater than the threshold Lth (step S21: Yes), the switching-method switching controller 91 selects the partial switching method as the switching method of the converter 2 (step S22). If the load L is less than or equal to the threshold Lth (step S21: No), the switching-method switching controller 91 selects the passive operation as the switching method of the converter 2 (step S23).

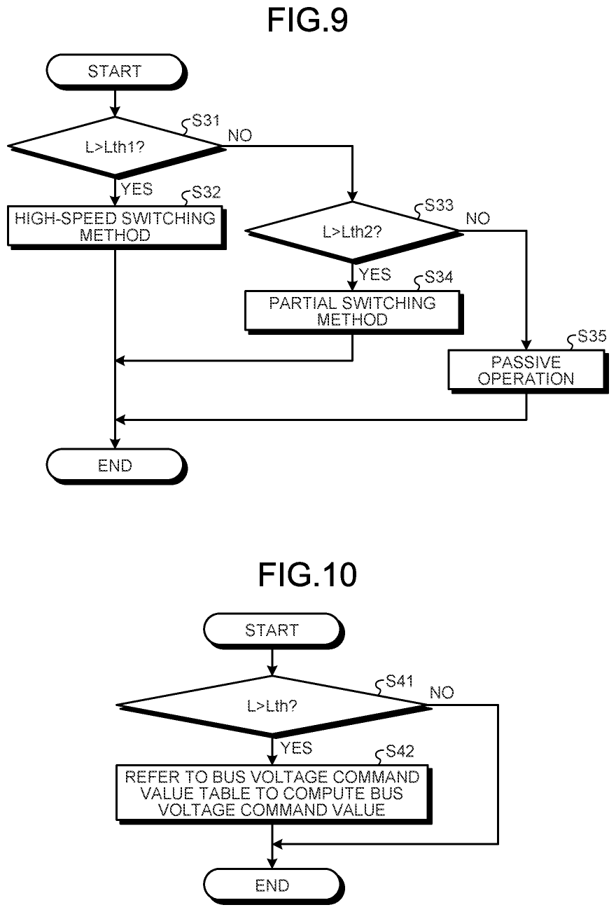

FIG. 9 is a third flowchart illustrating an operation of determination of the switching method performed by the controller 9 of the power converter 100 according to the first embodiment. Referring to FIG. 9, a case will be described in which the controller 9 switches among the high-speed switching method, the partial switching method, and the passive operation as the switching method of the converter 2. In the controller 9, the switching-method switching controller 91 compares the load L, which represents the magnitude of the AC power supplied from the converter 2 to the load 10, with a predetermined threshold Lth1 (step S31). If the load L is greater than the threshold Lth1 (step S31: Yes), the switching-method switching controller 91 selects the high-speed switching method as the switching method of the converter 2 (step S32). If the load L is less than or equal to the threshold Lth1 (step S31: No), the switching-method switching controller 91 compares the load L with a predetermined threshold Lth2 (step S33). Note that there is a relationship of threshold Lth1>threshold Lth2. If the load L is greater than the threshold Lth2 (step S33: Yes), the switching-method switching controller 91 selects the partial switching method as the switching method of the converter 2 (step S34). If the load L is less than or equal to the threshold Lth2 (step S33: No), the switching-method switching controller 91 selects the passive operation as the switching method of the converter 2 (step S35).

FIG. 10 is a flowchart illustrating an operation of computation of a bus voltage command value performed by the controller 9 of the power converter 100 according to the first embodiment. In the controller 9, the bus voltage command value computer 92 compares the load L, which represents the magnitude of the AC power supplied from the converter 2 to the load 10, with the predetermined threshold Lth (step S41). If the load L is greater than the threshold Lth (step S41: Yes), the bus voltage command value computer 92 refers to a bus voltage command value table using the load L to compute the bus voltage command value (step S42). The bus voltage command value table is a table that provides a bus voltage command value dependent on the magnitude of the load L. The bus voltage command value table is, for example, prepared based on results of simulation or actual measurement and/or the like, and stored in advance in the bus voltage command value computer 92, by the manufacturer or the user of the power converter 100. If the load L is less than or equal to the threshold Lth (step S41: No), the passive operation has been selected as the switching method of the converter 2 by the switching-method switching controller 91, and the bus voltage command value computer 92 therefore does not compute the bus voltage command value and terminates the process.

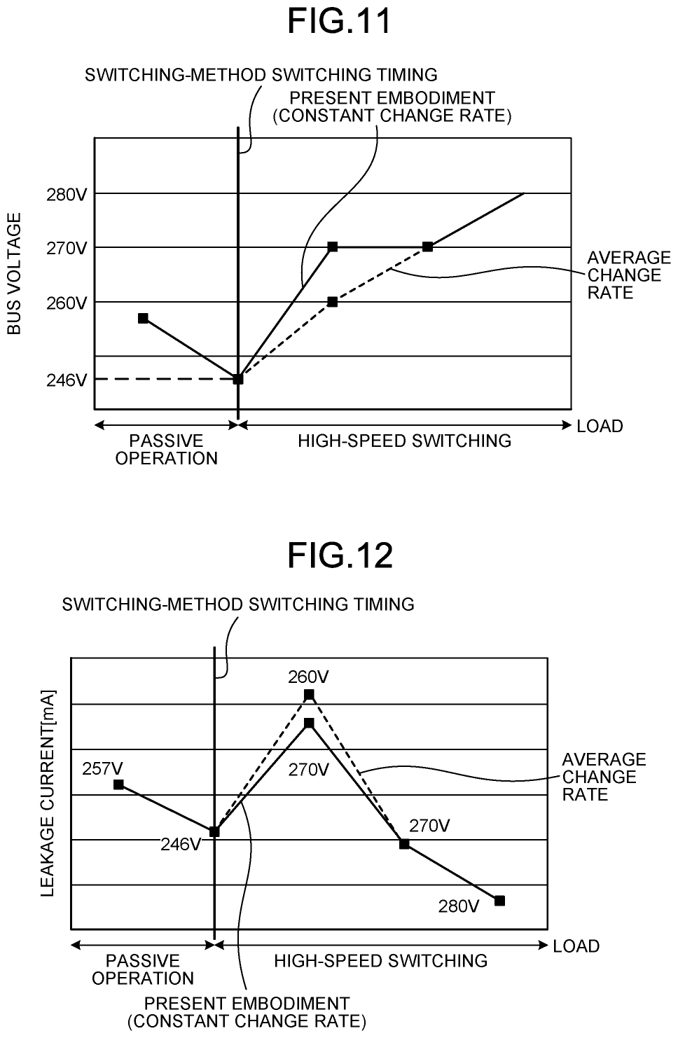

A method of computing the bus voltage command value by the bus voltage command value computer 92 upon switching of the switching method will next be described. FIG. 11 is a diagram illustrating a relationship between the load and the bus voltage when the switching method is switched from the passive operation to the high-speed switching method by the controller 9 of the power converter 100 according to the first embodiment. In FIG. 11, the horizontal axis represents the load, and the vertical axis represents the bus voltage. The controller 9 performs a passive operation when the load is low, and switches the switching method to the high-speed switching method when the load increases to a predetermined point. The predetermined point corresponds to the switching-method switching timing illustrated in FIG. 11, and is the foregoing threshold Lth with respect to the load L.

The power converter 100 does not cause the converter 2 to perform boost operation in the passive operation. The bus voltage detected by the power converter 100, i.e., the output voltage Vout detected by the bus voltage detector 7, during passive operation is accordingly the voltage that is left as it is. The power converter 100 performs boost operation after switching to the high-speed switching method to boost the bus voltage depending on the load. In this operation, the controller 9 of the power converter 100 computes the bus voltage command value, and controls the boost operation of the converter 2 to cause the bus voltage, i.e., the output voltage Vout detected by the bus voltage detector 7, to follow the bus voltage command value. In general, the conventional power converter presented herein as a comparative example computes the bus voltage command value to keep a change rate constant that represents how the bus voltage changes with a change in the magnitude of the load at the timing of switching of the switching method.

In contrast, the bus voltage command value computer 92 of the controller 9 computes the bus voltage command value to cause the change rate that represents how the bus voltage changes with a change in the magnitude of the load to be greater than an average change rate, which is the averaged change rate, rather than to keep constant, at the timing of switching of the switching method when the load is low. That is, the controller 9 computes the bus voltage command value to have a boost ratio greater than a boost ratio of the conventional technology presented as the comparative example. In the first embodiment, the bus voltage command value computer 92 of the controller 9 computes the bus voltage command value that has zones respectively having different change rates, which each represent how the bus voltage changes with a change in the magnitude of the load, during control of the boost operation of the converter 2. That is, the power converter 100 issues a bus voltage command value during the boost operation of the converter 2.

FIG. 12 is a diagram illustrating a relationship between the load and a leakage current when the switching method is switched by the controller 9 of the power converter 100 according to the first embodiment. The leakage current is, as described above, a current due to charge and discharge currents of parasitic capacitances of the MOSFETs 21 to 24 included in the converter 2. The leakage current after the switching has changed from the passive operation to the high-speed switching method is lower when the bus voltage is rapidly increased as in the first embodiment than when the bus voltage is increased at a constant change rate as in the conventional technology presented herein as the comparative example. The power converter 100 is configured such that the controller 9 rapidly increases the bus voltage at the timing of switching of the switching method, specifically, at the timing of switching from the passive operation to the high-speed switching method in the examples of FIGS. 11 and 12. That is, the controller 9 computes the bus voltage command value to cause the change rate of the bus voltage with respect to the magnitude of the load to be greater than the average change rate. This enables the power converter 100 to reduce the leakage current at the timing of switching of the switching method.

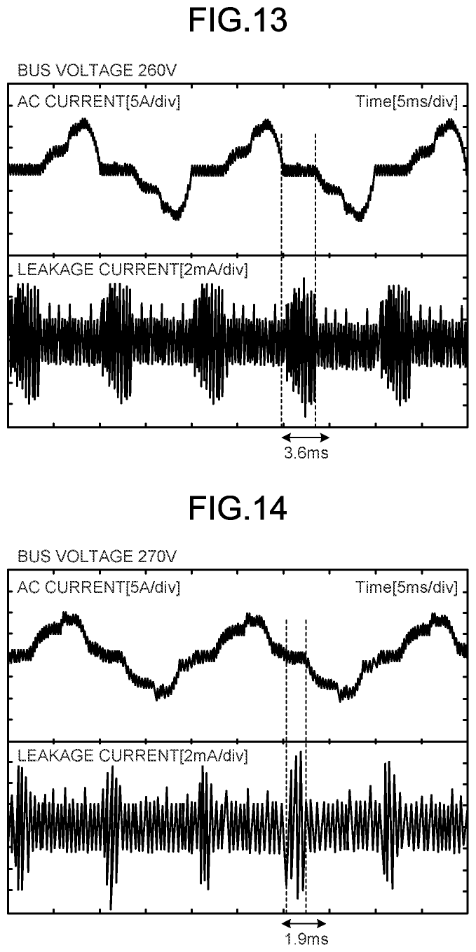

A reason that the power converter 100 can reduce the leakage current in the first embodiment will next be specifically described. FIG. 13 is a diagram illustrating waveforms of the AC current Iac and of the leakage current at a bus voltage of 260 V in the high-speed switching method in the power converter 100 of the first embodiment. FIG. 14 is a diagram illustrating waveforms of the AC current Iac and of the leakage current at a bus voltage of 270 V in the high-speed switching method in the power converter 100 of the first embodiment. In FIGS. 13 and 14, the horizontal axis represents time, and the vertical axis in the upper section represents the magnitude of the AC current Iac and the vertical axis in the lower section represents the magnitude of the leakage current. As illustrated in FIGS. 13 and 14, the leakage current increases during a time period when the AC current Iac has a zero value in the power converter 100. A comparison between FIGS. 13 and 14 indicates that the peak value of the leakage current during the time period when the AC current Iac has a zero value is greater at the bus voltage of 270 V than at the bus voltage of 260 V. Meanwhile, the time period in which the AC current Iac has a zero value and the leakage current increases is shorter at the bus voltage of 270 V than at the bus voltage of 260 V. That is, the results illustrated in FIGS. 12 to 14 indicate that the power converter 100 can reduce the leakage current by reducing the length of the time period of increase in the leakage current even when the peak value of the leakage current is high.

In the power converter 100, an increase in the bus voltage results in an improvement in the power factor, thereby reducing the length of the AC current zero period in which the leakage current increases, and thus reducing the leakage current. The power converter 100 computes the bus voltage command value to be higher than the value in the conventional technology presented herein as the comparative example, and can thus set a higher boost ratio for the converter 2. This increases the duty ratio with respect to the converter 2, thereby improving the controllability in generation of a waveform of the AC current Iac in the power converter 100. The power converter 100 can generate the waveform of the AC current Iac in a more sinusoidal shape. In contrast, an increase in the bus voltage increases the peak value of the leakage current in the power converter 100. An increase in the bus voltage leads to a trade-off between reduction in the length of the time period of increase in the leakage current and increase in the peak value of the leakage current. Accordingly, the power converter 100 needs optimum setting in computing the bus voltage command value. In the first embodiment, the manufacturer or the user of the power converter 100, as described above, prepares in advance the bus voltage command value table based on results of simulation or actual measurement and/or the like, and stores the bus voltage command value table in the bus voltage command value computer 92.

Thus, the controller 9 of the power converter 100 computes the bus voltage command value to cause the change rate to be greater than the average change rate, in a zone having a constant change rate from a point of a first load, which is the load upon switching, to a point of a second load, which is greater than or equal to the first load, upon switching between the passive operation and the high-speed switching method. Note that the first embodiment has been specifically described referring to FIGS. 11 and 12 in which the controller 9 of the power converter 100 switches the switching method of the converter 2 from the passive operation to the high-speed switching method, but the switching operation is not limited thereto.

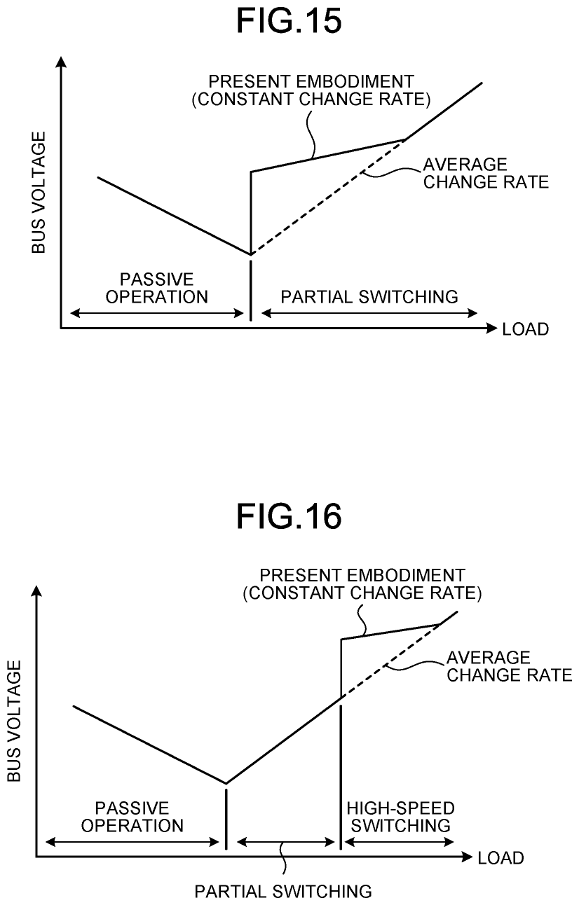

FIG. 15 is a diagram illustrating a relationship between the load and the bus voltage in a case in which the switching method is switched from the passive operation to the partial switching method by the controller 9 of the power converter 100 according to the first embodiment. The controller 9 of the power converter 100 computes the bus voltage command value to cause the change rate to be greater than the average change rate, in a zone having a constant change rate from a point of a first load, which is the load upon switching, to a point of a second load, which is greater than or equal to the first load, upon switching between the passive operation and the partial switching method.

FIG. 16 is a first diagram illustrating a relationship between the load and the bus voltage in a case in which the switching method is switched from the passive operation to the partial switching method and then from the partial switching method to the high-speed switching method by the controller 9 of the power converter 100 according to the first embodiment. The controller 9 of the power converter 100 computes the bus voltage command value, as illustrated in FIG. 16, to cause the change rate to be greater than the average change rate, in a zone having a constant change rate from a point of a first load, which is the load upon switching, to a point of a second load, which is greater than or equal to the first load, upon switching between the partial switching method and the high-speed switching method.

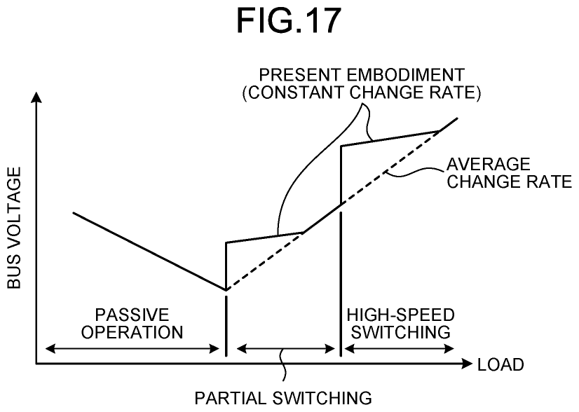

FIG. 17 is a second diagram illustrating a relationship between the load and the bus voltage in the case in which the switching method is switched from the passive operation to the partial switching method and then from the partial switching method to the high-speed switching method by the controller 9 of the power converter 100 according to the first embodiment. The controller 9 of the power converter 100 computes the bus voltage command value, as illustrated in FIG. 17, to cause the change rate to be greater than the average change rate, in a zone having a constant change rate from a point of a first load, which is the load upon switching, to a point of a second load, which is greater than or equal to the first load, upon switching between the passive operation and the partial switching method. The controller 9 of the power converter 100 also computes the bus voltage command value to cause the change rate to be greater than the average change rate, in a zone having a constant change rate from a point of a third load, which is the load upon switching, to a point of a fourth load, which is greater than or equal to the third load, upon switching between the partial switching method and the high-speed switching method.

The power converter 100 can reduce the leakage current at the timing of switching of the switching method in each of the cases illustrated in FIGS. 15 to 17.

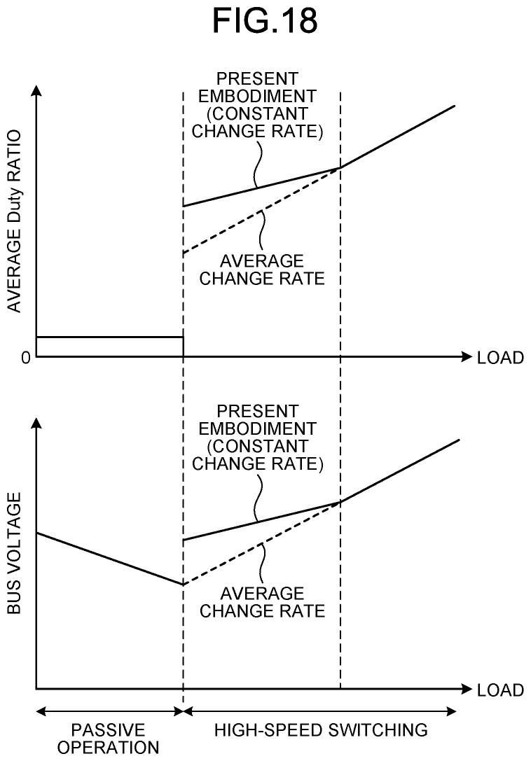

A relationship will now be described between the bus voltage detected by the power converter 100 and the duty ratio when the controller 9 of the power converter 100 turns on and off the MOSFETs 21 to 24, which are the semiconductor devices of the converter 2. FIG. 18 is a diagram illustrating relationships among the load, the bus voltage, and an average duty ratio in a case in which the switching method is switched from the passive operation to the high-speed switching method by the controller 9 of the power converter 100 according to the first embodiment. The average duty ratio is the averaged duty ratio when the controller 9 turns on the MOSFETs 21 to 24, which are the semiconductor devices of the converter 2. The average duty ratio will be described in detail later. As illustrated in FIG. 18, the power converter 100 has a duty ratio of zero in the passive operation, and becomes non-zero upon switching to the high-speed switching method. The conventional power converter used as the comparative example sets the average duty ratio to cause the change rate of the bus voltage with respect to the magnitude of the load to be constant at the timing of switching of the switching method from the passive operation to the high-speed switching method. In the first embodiment, the power converter 100 sets the average duty ratio to cause the change rate of the bus voltage with respect to the magnitude of the load to be greater than the average change rate at the timing of switching of the switching method from the passive operation to the high-speed switching method. As a result, the power converter 100 sets the average duty ratio to cause the change rate of the average duty ratio with respect to the magnitude of the load to be greater than the average change rate at the timing of switching of the switching method from the passive operation to the high-speed switching method.

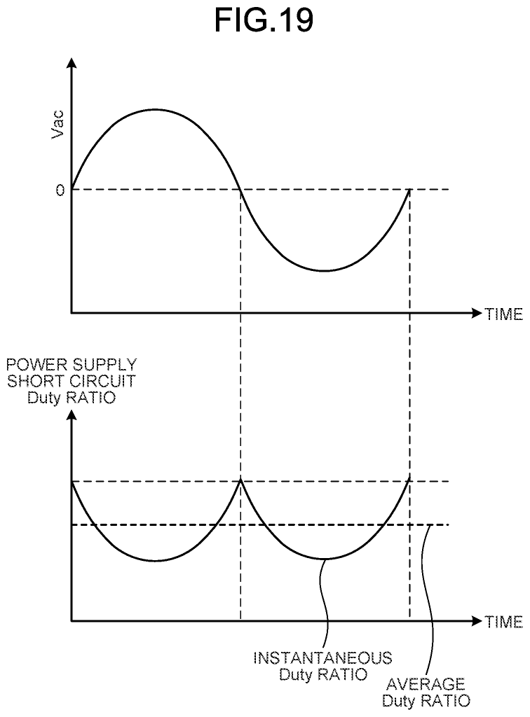

The average duty ratio will now be described. FIG. 19 is a diagram illustrating a relationship between a power source short circuit duty ratio and the AC voltage Vac from the AC power source 1 detected by the power converter 100 according to the first embodiment. As illustrated in FIG. 19, the power source short circuit duty ratio increases with approach to zero by the AC voltage Vac, and decreases with approach to the peak by the AC voltage Vac. The average value of this power source short circuit duty ratio is defined as the average duty ratio.

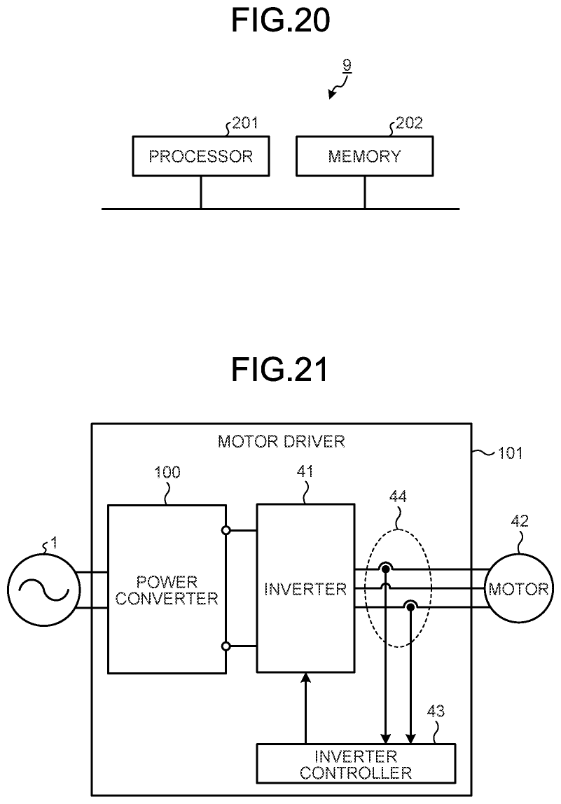

A hardware configuration of the controller 9 included in the power converter 100 will next be described. FIG. 20 is a diagram illustrating an example of hardware configuration that implements the controller 9 included in the power converter 100 according to the first embodiment. The controller 9 is implemented by a processor 201 and a memory 202.

The processor 201 is a central processing unit (CPU) (also known as a processing unit, a computing unit, a microprocessor, a microcomputer, a processor, and a digital signal processor (DSP)), or a system large scale integration (LSI). An example of the memory 202 is a non-volatile or volatile semiconductor memory such as a random access memory (RAM), a read-only memory (ROM), a flash memory, an erasable programmable read-only memory (EPROM), or an electrically erasable programmable read-only memory (EEPROM) (registered trademark). The memory 202 is not limited thereto, but may also be a magnetic disk, an optical disk, a compact disc, a MiniDisc, or a digital versatile disc (DVD).

As described above, according to the first embodiment, the power converter 100 is configured such that the controller 9 computes the bus voltage command value to cause the change rate in a zone in which the load is greater and in which the change rate is constant to be greater than the average change rate, which is the average of the change rate during the boost operation of the converter 2, at at least one timing of timings of switching of the switching method of the converter 2. This enables the power converter 100 to reduce the leakage current that occurs in the MOSFETs 21 to 24 included in the converter 2 upon switching of the switching method.

### Second Embodiment

In the description of a second embodiment, a motor driver including the power converter 100 described in the first embodiment will be described.

FIG. 21 is a diagram illustrating an example configuration of a motor driver 101 according to the second embodiment. The motor driver 101 drives a motor 42, which is a load. The motor driver 101 includes the power converter 100 of the first embodiment, an inverter 41, a motor current detector 44, and an inverter controller 43. The inverter 41 converts DC power supplied from the power converter 100 into AC power, and outputs the AC power to the motor 42 to drive the motor 42. Note that although the description is and will be provided regarding a case in which the load of the motor driver 101 is the motor 42, this is merely by way of example. The device to be connected to the inverter 41 may be any device that is to receive AC power, and may be other than the motor 42.

The inverter 41 is a circuit including switching elements such as IGBTs coupled in a three-phase bridge configuration or in a two-phase bridge configuration. The switching elements used in the inverter 41 are not each limited to an IGBT, but may be a switching element formed of a wide band gap (WBG) semiconductor, an integrated gate commutated thyristor (IGCT), a field-effect transistor (FET), or a MOSFET.

The motor current detector 44 detects a current flowing between the inverter 41 and the motor 42. The inverter controller 43 generates PWM signals to drive the switching elements in the inverter 41 to cause the motor 42 to rotate at a desired rotational speed, using the value of the current detected by the motor current detector 44, and applies the PWM signals to the inverter 41. The inverter controller 43 is implemented, similarly to the controller 9, by a processor and a memory. Note that the inverter controller 43 of the motor driver 101 and the controller 9 of the power converter 100 may be implemented together in a single circuit.

When the power converter 100 is used in the motor driver 101, the output voltage Vout, which is the bus voltage required for control of the converter 2, varies depending on the operation state of the motor 42. Providing a higher rotational speed of the motor 42 generally requires a higher output voltage of the inverter 41. The upper limit of this output voltage of the inverter 41 is limited by the input voltage to the inverter 41, i.e., the output voltage Vout, which is the output from the power converter 100. The region in which the output voltage from the inverter 41 exceeds the upper limit limited by the output voltage Vout and gets saturated is referred to as overmodulation region.

In such motor driver 101, the motor 42 rotating at a rotational speed in a low rotational speed range, that is, in a range below the overmodulation region, requires no boosting of the output voltage Vout. In contrast, when the motor 42 rotates at a high rotational speed, boosting of the output voltage Vout enables the overmodulation region to move toward a higher rotational speed. This can expand the operation range of the motor 42 toward a higher rotational speed.

Alternatively, when there is no need to expand the operation range of the motor 42, the number of turns of the winding of the stator included in the motor 42 can correspondingly be increased. An increase in the number of turns of the winding increases the motor voltage generated across both ends of the winding in a low rotational speed range, which accordingly reduces the amount of current flowing through the winding, thereby enabling a reduction in the loss due to switching operation of the switching elements in the inverter 41. When both of the advantages of expansion of the operation range of the motor 42 and improvement of loss in a low rotational speed range are needed, the number of turns of the winding of the motor 42 is set to an appropriate value.

As described above, according to the second embodiment, the use of the power converter 100 reduces imbalance of heat generation between the arms, and can thus provide the highly reliable, high-output motor driver 101.

### Third Embodiment

In the description of a third embodiment, an air conditioner including the motor driver 101 described in the second embodiment will be described.

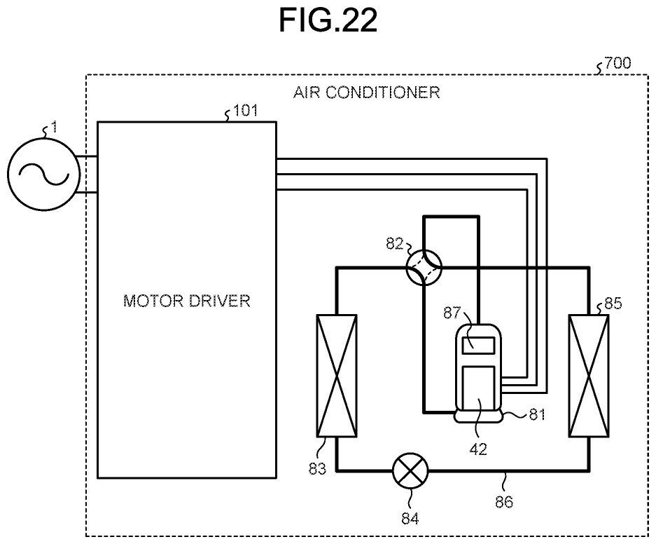

FIG. 22 is a diagram illustrating an example configuration of an air conditioner 700 according to the third embodiment. The air conditioner 700 is an example of refrigeration cycle apparatus, and includes the motor driver 101 and the motor 42 of the second embodiment. The air conditioner 700 includes a compressor 81 incorporating a compression mechanism 87 and the motor 42, a four-way valve 82, an outdoor heat exchanger 83, an expansion valve 84, an indoor heat exchanger 85, and a refrigerant pipe 86. The air conditioner 700 is not limited to a separate type air conditioner having the outdoor unit separated from the indoor unit, but may also be an integrated air conditioner having the compressor 81, the indoor heat exchanger 85, and the outdoor heat exchanger 83 being housed in a single housing. The motor 42 is driven by the motor driver 101.

The compressor 81 includes therein the compression mechanism 87, which compresses the refrigerant, and the motor 42, which operates the compression mechanism 87. Circulation of the refrigerant through the compressor 81, the four-way valve 82, the outdoor heat exchanger 83, the expansion valve 84, the indoor heat exchanger 85, and the refrigerant pipe 86 forms a refrigeration cycle. Note that components included in the air conditioner 700 are also applicable to a device such as a refrigerator or a freezer including a refrigeration cycle.

In addition, the third embodiment has been described in the context of an example configuration in which the motor 42 is used as the drive source of the compressor 81, and the motor driver 101 drives the motor 42. However, a configuration may be used in which the motor 42 is used as the drive source to drive an indoor unit blower and outdoor unit blower (not illustrated) included in the air conditioner 700, and the motor 42 is driven by the motor driver 101. Alternatively, a configuration may also be used in which the motor 42 is used as the drive source for the indoor unit blower, for the outdoor unit blower, and for the compressor 81, and the motor 42 is driven by the motor driver 101.

Meanwhile, the air conditioner 700 operates predominantly under an intermediate condition in which the output is less than or equal to half the rated output, that is, under a low output condition, throughout the year. Thus, operation under the intermediate condition greatly contribute to annual power consumption. In addition, the air conditioner 700 tends to undergo a low rotational speed of the motor 42, and a low output voltage Vout required to drive the motor 42. Thus, the switching elements used in the air conditioner 700 operate more effectively in a passive state in terms of system efficiency. The power converter 100 capable of reducing loss in a wide operation mode range including the passive state and the high frequency switching state is therefore useful for the air conditioner 700. Although use of an interleave approach can provide size reduction of the reactor 3, the air conditioner 700 does not need a size reduction of the reactor 3 due to a high proportion of operation under intermediate condition as described above. Thus, the configuration and operation of the power converter 100 are more advantageous in terms of harmonic reduction and power source power factor.

In addition, the power converter 100 is capable of reducing switching loss, which can thus reduce a temperature rise of the power converter 100. Accordingly, a size reduction of an outdoor unit blower (not illustrated) can still retain the cooling capability on the substrate installed in the power converter 100. Thus, the power converter 100 is suitable for the high efficiency air conditioner 700 having a high output of 4.0 kW or higher.

Moreover, according to the third embodiment, the use of the power converter 100 reduces imbalance of heat generation between the arms, and can thus provide size reduction of the reactor 3 by high frequency driving of the switching elements, and suppress increase in the weight of the air conditioner 700. Furthermore, according to the third embodiment, high frequency driving of the switching elements enables the high efficiency air conditioner 700 to be provided that has reduced switching loss, and hence a low energy consumption rate.

The configurations described in the foregoing embodiments are merely examples of various aspects of the present invention. These configurations may be combined with a known other technology, and moreover, a part of such configurations may be omitted and/or modified without departing from the spirit of the present invention.

1. A power converter comprising:
a converter that converts alternating current power output from an alternating current power source into direct current power, the converter including switching elements;
a reactor disposed between the alternating current power source and the converter;
a smoothing capacitor connected to both ends of a direct current terminal of the converter; and
a plurality of detectors that detect a physical quantity representing an operational state of the converter, wherein
a bus voltage command value is issued that has zones respectively having different change rates during boost operation of the converter, the different change rates each representing how a bus voltage included in the physical quantity changes with a change in a magnitude of a load obtained from the physical quantity.

2. The power converter according to claim 1, comprising:
a switching-method switching controller that determines a switching method of the converter based on the physical quantity; and
a bus voltage command value computer that computes the bus voltage command value based on the physical quantity and on the switching method determined by the switching-method switching controller, wherein
the bus voltage command value computer computes the bus voltage command value to cause a change rate in a zone in which the load is greater and the change rate is constant to be greater than an average change rate at at least one timing of timings of switching of the switching method, the average change rate being an average of the change rates during the boost operation of the converter.

3. The power converter according to claim 2, wherein
the switching-method switching controller has, as the switching method,
a passive operation including at least one switching method of a diode rectification method in which the switching elements are turned off during an entire period of the alternating current power source or a synchronous rectification method in which the switching elements are controlled in synchronization with polarity of the power from the alternating current power source, and
a partial switching method in which control is repeatedly performed to partially short-circuit the reactor to the alternating current power source during a half period of the alternating current power source, up to a specified number of times.

4. The power converter according to claim 2, wherein
the switching-method switching controller has, as the switching method,
a passive operation including at least one switching method of a diode rectification method in which the switching elements are turned off during an entire period of the alternating current power source or a synchronous rectification method in which the switching elements are controlled in synchronization with polarity of the power from the alternating current power source, and
a high-speed switching method in which switching is performed to short-circuit the reactor at a specified frequency during an entire alternating current period of the alternating current power source.

5. The power converter according to claim 2, wherein
the switching-method switching controller has, as the switching method,
a passive operation including at least one switching method of a diode rectification method in which the switching elements are turned off during an entire period of the alternating current power source or a synchronous rectification method in which the switching elements are controlled in synchronization with polarity of the power from the alternating current power source,
a partial switching method in which control is repeatedly performed to partially short-circuit the reactor to the alternating current power source during a half period of the alternating current power source, up to a specified number of times, and
a high-speed switching method in which switching is performed to short-circuit the reactor at a specified frequency during an entire alternating current period of the alternating current power source.

6. The power converter according to claim 3, wherein the bus voltage command value is issued to cause the change rate in a zone to be greater than the average change rate upon switching between the passive operation and the partial switching method, the zone having a constant change rate and being from a point of a first load to a point of a second load, the first load being a load upon the switching, the second load being greater than or equal to the first load.

7. The power converter according to claim 4, wherein the bus voltage command value is issued to cause the change rate in a zone to be greater than the average change rate upon switching between the passive operation and the high-speed switching method, the zone having a constant change rate and being from a point of a first load to a point of a second load, the first load being a load upon the switching, the second load being greater than or equal to the first load.

8. The power converter according to claim 5, wherein the bus voltage command value is issued to cause the change rate in a zone to be greater than the average change rate upon switching between the partial switching method and the high-speed switching method, the zone having a constant change rate and being from a point of a first load to a point of a second load, the first load being a load upon the switching, the second load being greater than or equal to the first load.

9. The power converter according to claim 5, wherein
the bus voltage command value is issued to cause the change rate in a zone to be greater than the average change rate upon switching between the passive operation and the partial switching method, the zone having a constant change rate and being from a point of a first load to a point of a second load, the first load being a load upon the switching, the second load being greater than or equal to the first load, and
the bus voltage command value is issued to cause the change rate in a zone to be greater than the average change rate upon switching between the partial switching method and the high-speed switching method, the zone having a constant change rate and being from a point of a third load to a point of a fourth load, the third load being a load upon the switching, the fourth load being greater than or equal to the third load.

10. An air conditioner comprising:
a motor;
the power converter according to claim 1; and
an inverter that converts direct current power output from the power converter into alternating current power, and outputs the alternating current power to the motor.

11. The power converter according to claim 5, wherein the bus voltage command value is issued to cause the change rate in a zone to be greater than the average change rate upon switching between the passive operation and the partial switching method, the zone having a constant change rate and being from a point of a first load to a point of a second load, the first load being a load upon the switching, the second load being greater than or equal to the first load.

12. The power converter according to claim 5, wherein the bus voltage command value is issued to cause the change rate in a zone to be greater than the average change rate upon switching between the passive operation and the high-speed switching method, the zone having a constant change rate and being from a point of a first load to a point of a second load, the first load being a load upon the switching, the second load being greater than or equal to the first load.
